(19) United States
(12) Patent Application Publication
(10) Pub. No.: US 2018/0329649 A1
(43) Pub. Date: Nov. 15, 2018

(54) Flash Memory Devices and Prefetch Methods Thereof

(71) Applicant: Silicon Motion, Inc., Jhubei City (TW)

(72) Inventors: Jieh-Hsin Chien, Taoyuan City (TW); Yi-Hua Pao, Hsinchu City (TW)

(73) Assignee: Silicon Motion, Inc.

(21) Appl. No.: 15/954,308

(22) Filed: Apr. 16, 2018

Related U.S. Application Data
(60) Provisional application No. 62/504,140, filed on May 10, 2017.

(30) Foreign Application Priority Data
Sep. 1, 2017 (TW) 106129948

(51) Int. Cl. G06F 3/06

(52) U.S. Cl. CPC G06F 3/0656; G06F 3/0679; G06F 3/0653; G06F 3/0619

(57) ABSTRACT

A storage device includes a flash memory array and a controller. The flash memory array includes a plurality of blocks which are configured to store data. The controller scans the flash memory array during an idle time to confirm the accuracy of the data stored in the flash memory array.

### CROSS REFERENCE TO RELATED APPLICATIONS

This application claims the benefit of U.S. Provisional Application No. 62/504,140, filed on May 10, 2017, the entirety of which is incorporated by reference herein.

This Application claims priority of Taiwan Patent Application No. 106129948, filed on Sep. 1, 2017, the entirety of which is incorporated by reference herein.

### BACKGROUND OF THE INVENTION

### Field of the Invention

The disclosure relates generally to a flash memory device and a pre-fetch method thereof.

### Description of the Related Art

When a system is powered on, the solid-state disk is usually powered on as well. However, there is an idle time that lasts from when the solid-state disk is powered on to when the solid-state disk is first accessed. In order to effectively improve the performance of the solid-state disk, it is necessary to utilize this idle time more efficiently, and then to improve the access speed of the solid-state disk.

### BRIEF SUMMARY OF THE INVENTION

In an embodiment, a storage device comprises a flash memory array and a controller. The flash memory array comprises a plurality of blocks, wherein the blocks are configured to store data. The controller scans the flash memory during an idle time to confirm the accuracy of the data stored in the flash memory array.

According to an embodiment of the invention, the idle time is the period of time between when the storage device is initialized and when a host is initialized.

According to another embodiment of the invention, the idle time is the period between when the storage device is initialized and when an access instruction is received from the host.

According to an embodiment of the invention, when the controller scans the flash memory array, the controller selectively scans at least one of pages of each of the blocks to determine whether the number of error bits in any of the scanned page(s) exceeds a threshold.

According to an embodiment of the invention, when the number of error bits in any of the pages exceeds the threshold, the controller performs a refresh process on the flash memory array.

According to another embodiment of the invention, when the number of error bits in any of the pages exceeds the threshold, the controller performs a refresh process on the blocks corresponding to the pages with the excessive number of error bits.

In an embodiment, a refresh method adopted in a storage device comprises: initializing the storage device; scanning the storage device during an idle time to determine the accuracy of the data stored in the storage device; and entering a stand-by state to receive an access instruction.

According to an embodiment of the invention, the idle time is a period of time between when the storage device is initialized and when the host is initialized.

According to another embodiment of the invention, the idle time is a period between when the storage device is initialized and when an access instruction is received from the host.

According to an embodiment of the invention, the storage device comprises a flash memory array, wherein the flash memory array comprises a plurality of blocks, wherein the step of scanning the storage device during the idle time to determine the accuracy of the data stored in the storage device further comprises: scanning at least one of the pages of each of the blocks; determining whether a number of error bits in any of the scanned page(s) exceeds a threshold; and when the number of error bits in any of the pages exceeds the threshold, performing a refresh process on the flash memory array.

According to another embodiment of the invention, the storage device comprises a flash memory array, and the flash memory array comprises a plurality of blocks, wherein the step of scanning the storage device during the idle time to determine the accuracy of the data stored in the storage device further comprises: scanning at least one of the pages of each of the blocks; determining whether the number of error bits in the scanned page(s) exceeds a threshold; and when the number of error bits in any of the pages exceeds the threshold, performing a refresh process on the blocks corresponding to the pages with the excessive number of error bits.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of a storage device in accordance with an embodiment of the invention; and

FIG. 2 is a block diagram of a power-on access table in accordance with an embodiment of the invention.

### DETAILED DESCRIPTION OF THE INVENTION

This description is made for the purpose of illustrating the general principles of the invention and should not be taken in a limiting sense. In addition, the present disclosure may repeat reference numerals and/or letters in the various examples. This repetition is for the purpose of simplicity and clarity and does not in itself dictate a relationship between the various embodiments and/or configurations discussed. The scope of the invention is best determined by reference to the appended claims.

It should be understood that the following disclosure provides many different embodiments, or examples, for implementing different features of the application. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are formed in direct contact, and may also include embodiments in which additional features may be formed interposing the features, such that the features may not be in direct contact.

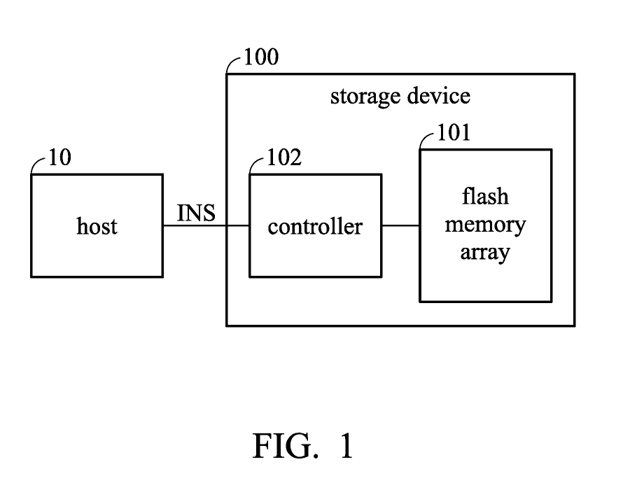

FIG. 1 is a block diagram of a storage device in accordance with an embodiment of the invention. As shown in FIG. 1, the storage device 100 includes a flash memory array 101 and a controller 102, wherein the storage device 100 is coupled to the host 10, and the host 10 and the storage device 100 form a system. According to an embodiment of the invention, the storage device 100 may be a physical interface adopted in the protocol of USB, UFS, eMMC, SD, Memory Stick, Compact Flash, CFast, SAS (Serial Attached SCSI), SATA, PATA, or PCIE, or a solid-state disk adopted in the protocol of USB, NVME, AHCI, or SCSI.

When the host 10 begins initializing, the host 10 also requests the peripheral devices, such as storage device 100, to begin initializing. Since the initialization time of the storage device 100 is less than that of the host 10, there is an idle time. The idle time is defined as the period of time after the storage device 100 has accomplished initialization, and before the host 10 has accomplished initialization. According to an embodiment of the invention, the flash memory array 101 includes a plurality of blocks, wherein each block includes a plurality of pages configured to store data. Since the storage device 100 can be rapidly initialized, the idle time may be the period between when the storage device 100 is initialized after the storage device 10 is powered on and when the access instruction INS is received from the host 10 to begin to access the storage device 100.

During the idle time, the controller 102 may actively scan the pages of the flash memory array 101, in order to confirm the accuracy of the data stored in the flash memory array 101. According to an embodiment of the invention, when the controller 102 actively scans the flash memory array 101, the controller 102 selectively scans the pages of the flash memory array 101 to determine whether the number of error bits in any of the scanned pages exceeds a threshold. According to other embodiments of the invention, the controller 102 may utilize any sampling method to scan each, or at least one, of the pages in the plurality of pages to determine whether the number of error bits in any of the sampled pages exceeds a threshold.

According to an embodiment of the invention, when the number of error bits in any of the sampled pages exceeds the threshold, this indicates that the data stored in the flash memory array 101 has a problem with data retention. Thus, the controller 102 performs a refresh process on the whole flash memory array 101 to improve the accuracy of the data stored in the flash memory array 101.

According to another embodiment of the invention, when the controller 102 scans the flash memory array 101, the controller 102 scans at least one page in each block and determines whether the number of error bits in any of the scanned pages exceeds the threshold. When the number of error bits in any of the scanned pages exceeds the threshold, this indicates that the data stored in the block corresponding to the scanned page with the excessive number of error bits has a problem with data retention. Therefore, the controller 102 performs a refresh process on the block corresponding to the scanned page with the excessive number of error bits, so that the accuracy of the data stored in the block is improved.

According to other embodiments of the invention, the controller 102 may utilize any kind of sampling method, which is not intended to be limiting thereto, to selectively scan the pages of the flash memory array 101 and perform a refresh process on the corresponding blocks, dies, or the whole flash memory array 101 which is illustrated herein, but it is not intended to be limited thereto.

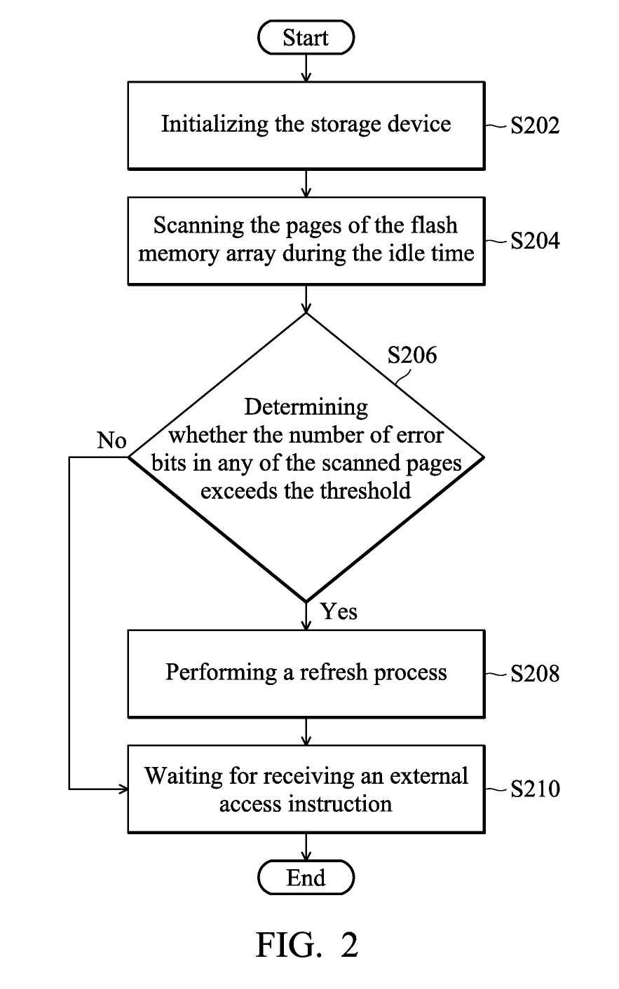

FIG. 2 is a block diagram of a power-on access table in accordance with an embodiment of the invention. The following flow chart in FIG. 2 will be described with FIG. 1, for the sake of detailed explanation. The storage device 100 is initialized (Step S202). When the storage device 100 is powered on, powered on again, or re-started, the initialization can be accomplished rapidly. The controller 102 scans the pages of the flash memory array 101 during the idle time (Step S204) to confirm the accuracy of the data stored in the flash memory array 101. According to an embodiment of the invention, the idle time is defined as the period of time after the storage device 100 has accomplished initialization, and before the host 10 has accomplished initialization. The idle time may also be defined as the period of time after the storage device 100 has been powered ON and has accomplished initialization, and before the access instruction INS is received from the host 10. According to an embodiment of the invention, the controller 102 in FIG. 1 randomly scans the pages of the flash memory array 101. According to other embodiments of the invention, the controller 102 may utilize any sampling method to scan each, or at least one, of the pages of the blocks in the flash memory array 101.

Then, a determination is made as to whether the number of error bits in any of the scanned pages exceeds the threshold (Step S206). According to an embodiment of the invention, Step S204 combined with Step S206 are configured to scan the data stored in the storage device 100, in order to confirm the accuracy of the data stored in the storage device 100. When the number of error bits in any of the scanned pages exceeds the threshold, a refresh process is performed (Step S208). The storage device 100 then enters a stand-by state to receive the access instruction INS from the host 10 (Step S210). When the number of error bits in any of the scanned pages does not exceed the threshold, Step S204 is repeated and Step S210 is not performed until all, or a default number, of the pages are scanned. In addition, when the access instruction INS from the host 10 is received in the process of scanning the pages, the process of scanning the pages is suspended to skip to Step S210. Once the storage device 100 returns to the stand-by state, the suspended process of scanning the pages is resumed. The flow of the refresh method provided herein is accomplished until all, or a default number, of the pages have been scanned.

According to an embodiment of the invention, when the number of error bits in any of the scanned pages exceeds the threshold, a refresh process is performed on the whole flash memory array 101 to improve the accuracy of the data in the flash memory array 101. According to another embodiment of the invention, when the number of error bits in any of the scanned pages exceeds the threshold, a refresh process is performed on the blocks corresponding to the pages with the excessive number of error bits to improve the accuracy of the data stored in the blocks.

According to other embodiments of the invention, the controller 102 may utilize any sampling method, which is not intended to be limiting thereto, to selectively scan the pages in the flash memory array 101 and perform a refresh process on the blocks, dies, or the whole flash memory array 101 which is illustrated herein but is not intended to be limited thereto.

Since the storage device 100 is in the stand-by state during the idle time (i.e., the period of time after the storage device 100 has accomplished initialization, and before the host 10 has accomplished initialization), not only is the period prior to the host 10 accomplishing the initialization being utilized efficiently, but also the accuracy of the data accessed afterward by the host 10 is improved when the storage device 100 is scanned and refreshed during the idle time

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A storage device, comprising:
a flash memory array, comprising a plurality of blocks, wherein the blocks are configured to store data; and
a controller, scanning the flash memory during an idle time to confirm accuracy of the data stored in the flash memory array.

2. The storage device of claim 1, wherein the idle time is a period of time between when the storage device is initialized and when a host is initialized.

3. The storage device of claim 1, wherein the idle time is a period of time between when the storage device is initialized and when an access instruction is received from the host.

4. The storage device of claim 1, wherein when the controller scans the flash memory array, the controller selectively scans at least one of pages of each of the blocks to determine whether a number of error bits in any of the scanned page(s) exceeds a threshold.

5. The storage device of claim 4, wherein when the number of error bits in any of the pages exceeds the threshold, the controller performs a refresh process on the flash memory array.

6. The storage device of claim 4, wherein when the number of error bits in any of the pages exceeds the threshold, the controller performs a refresh process on the blocks corresponding to the pages with the excessive number of error bits.

7. A refresh method, adopted in a storage device, wherein the refresh method comprises:
initializing the storage device;
scanning the storage device during an idle time to determine accuracy of data stored in the storage device; and
entering a stand-by state to receive an access instruction.

8. The refresh method of claim 7, wherein the idle time is a period between when the storage device is initialized to when the host is initialized.

9. The refresh method of claim 7, wherein the idle time is a period between when the storage device is initialized and when an access instruction is received from the host.

10. The refresh method of claim 7, wherein the storage device comprises a flash memory array, wherein the flash memory array comprises a plurality of blocks, wherein the step of scanning the storage device during the idle time to determine the accuracy of the data stored in the storage device further comprises:
scanning at least one of the pages of each of the blocks;
determining whether a number of error bits in any of the scanned page(s) exceeds a threshold; and
when the number of error bits in any of the pages exceeds a threshold, performing a refresh process on the flash memory array.

11. The refresh method of claim 7, wherein the storage device comprises a flash memory array, and the flash memory array comprises a plurality of blocks, wherein the step of scanning the storage device during the idle time to determine the accuracy of the data stored in the storage device further comprises:
scanning at least one of the pages of each of the blocks;
determining whether the number of error bits in the scanned page(s) exceeds a threshold; and
when the number of error bits in any of the pages exceeds a threshold, performing a refresh process on the blocks corresponding to the pages with the excessive number of error bits.
